(19) United States
(12) Patent Application Publication
(10) Pub. No.: US 2004/0151315 A1
(43) Pub. Date: Aug. 5, 2004

(54) Streaming media security system and method

(76) Inventor: Hee Jean Kim, Hong Kong (CN)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/657,754

(22) Filed: Sep. 9, 2003

Related U.S. Application Data
(60) Provisional application No. 60/423,993, filed on Nov. 6, 2002.
(60) Provisional application No. 60/425,249, filed on Nov. 12, 2002.

(51) Int. Cl. H04N 7/167

(52) U.S. Cl. 380/241; 705/51

(57) ABSTRACT

A system and method of receiving real-time multimedia via a network, includes transmitting a request for the multimedia from a client interface. The request obtains a reply response containing a control message having a first encryption key and a unique software identifier containing an entitlement message, which has a second encryption key. The control message defines content stream information and access criteria, and the entitlement message defines the client interface entitlement rights. The unique software identifier decrypts the multimedia in real-time, in accordance with the content stream information and access criteria, in order to render the multimedia at the client interface.

### CROSS-REFERENCE TO RELATED APPLICATIONS

This Application claims the benefit of U.S. Provisional Patent Application No. 60/423,993 filed Nov. 6, 2002, and U.S. Provisional Patent Application No. 60/425,249 filed Nov. 12, 2002, the contents of each are incorporated herein by reference.

### BACKGROUND OF THE INVENTION

1. Field of the Invention

The present invention relates to processes and systems for providing streaming media content privacy. Specifically, the present invention relates to processes and systems that ensure streaming content delivery and distribution security over computer networks by utilizing real-time, dynamic encryption.

2. Description of the Related Art

Conventional digital TV broadcasting companies use a conditional access system to provide secure commercial program services by encryption. Typically when a broadcasting company provides commercial services, programs are encrypted and the broadcasting company controls the access rights of a subscriber such that the subscriber is prohibited from watching programs without payment. Content encryption is essential in order to ensure that the broadcaster maintains control of the content distribution.

One conventional conditional access system uses a physical smart card, such as an electronic channel box or digital receiver that is attached to a television. These physical smart cards usually comply with ISO/IEC 7816 and allow subscribers to store their access right so that they can decrypt the encrypted program. However, these devices are inconvenient because they have to be physically attached to the television, and therefore, lack portability and flexibility.

Internet streaming media services operate in a similar fashion to the digital TV broadcasting services. Such media services are gaining popularity, as well as the demand for the same or higher level of content security system to minimize content piracy. However, physical smart card readers are not common among Internet users, and in addition, physical smart cards are inconvenient and are too technical support intensive. As a result, the conventional conditional access system that uses a physical smart card is a major hindrance for the computer user who wants to adopt this kind of service. Thus, there is a need for new and improved methods and systems that provide for easy access to secure web-based content streams in real-time.

### SUMMARY OF THE INVENTION

The present invention provides a method of receiving real-time multimedia via a network. The method includes the steps of: transmitting a request for the multimedia from a client interface, wherein the request obtains a reply response containing a control message having a first encryption key, a unique software identifier containing an entitlement message, which has a second encryption key, the control message defining content stream information and access criteria, and the entitlement message defining the client interface entitlement rights; and receiving the reply, wherein the unique software identifier decrypts the multimedia in real-time, in accordance with the content stream information and access criteria, in order to render the multimedia at the client interface.

The present invention further provides a method of providing real-time multimedia via the Internet. The method includes the steps of: receiving a request for multimedia and validating the request; if the request is authorized in the validating step, generating a reply response containing a control message having a first encryption key, a unique software identifier containing an entitlement message which has a second encryption key, the control message defining the content stream information and access criteria, and the entitlement message defining the user interface entitlement rights; and transmitting the reply response, the reply response being configured so that the unique software identifier decrypts the multimedia in real-time, in accordance with the content stream information and access criteria, in order to render the multimedia at the client interface.

The present invention further provides a system for providing real-time multimedia having a media source configured to generate audio/video content stream. A code generator is configured to generate a plurality of distinct codes, a unique software identifier, and a plurality of messages. A media encoder is configured to convert the audio/video content stream to a particular format and to provide non-encrypted multimedia to a media encryptor. A media encryptor is configured to dynamically encrypt the non-encrypted multimedia with at least one distinct code and to transmit the encrypted multimedia to a media server. A media server is configured to store the encrypted multimedia and to provide the encrypted multimedia stream link to a web server. A web server is configured to register an end-user and to provide the encrypted multimedia to the end-user. An end-user is configured to receive the encrypted multimedia stream link and takes the encrypted multimedia using the encrypted multimedia link. The unique software identifier is configured to decrypt the multimedia in real-time in order to render the multimedia at the end-user.

The present invention further provides a method of providing broadcast content security. The method includes the steps of: registering with a web content provider; requesting broadcast content from the web content provider; requesting a software voucher from a media operator; at a key bank, receiving and validating the request, then generating the activation code and a unique software identifier; and sending the activation code and the unique software identifier to the end-user and storing the activation code corresponding to the previous voucher.

Still further, the present invention provides a method of accessing encrypted broadcast content stream. The method includes the steps of: selecting an encrypted broadcast content stream; checking the entitlement of the encrypted broadcast content stream; determining whether an end-user has entitlement corresponding to the encrypted broadcast content stream by means of a unique software identifier and an activation code; sending a link for the encrypted broadcast content stream to the end-user; and decrypting the encrypted broadcast content stream.

The present invention still further provides a system for dynamically receiving and displaying encrypted multimedia content. The system includes a client interface coupled with a network. The client interface is configured to generate a request for the content. The request obtains a reply response containing a control message having a first encryption key, a unique software identifier containing an entitlement message, which has a encryption second key, the control message defining the content stream information and access criteria, and the entitlement message defining the user interface entitlement rights. The client interface is configured to download the reply response and decrypt the multimedia in real-time, in accordance with the content stream information and access criteria, in order to render the multimedia at the client interface.

Still further, the present invention provides a system for dynamically providing and displaying encrypted multi-media content. The system includes a network server configured to receive and validate a request for multimedia. An encryption component is provided in communication with the network server and configured to generate a reply in response to the request. The response contains a control message having a first encryption key, a unique software identifier containing an entitlement message which has a second encryption key, the control message defining the content stream information and access criteria, and the entitlement message defining the user interface entitlement rights. The unique software identifier is configured to decrypt the multimedia in real-time, in accordance with the content stream information and access criteria, in order to render the multimedia at a client interface.

### BRIEF DESCRIPTION OF THE FIGURES

The objects and features of the invention will be more readily understood with reference to the following description and the attached drawings, wherein:

FIG. 1 is a system diagram of a system for providing dynamic encrypted streaming multimedia over a computer network according to an embodiment of the present invention;

FIG. 2 illustrates the format of an entitlement control message used for communication according to an embodiment of the present invention;

FIG. 3 illustrates the format of an entitlement management message according to an embodiment of the present invention;

FIG. 4 illustrates the format of a voucher according to an embodiment of the present invention;

FIG. 5 illustrates the format of an activation code according to an embodiment of the present invention;

FIG. 6 is a flow diagram of the registration process according to an embodiment of the present invention; and

FIG. 7 is a flow diagram of the service access process according to an embodiment of the present invention.

### DETAILED DESCRIPTION OF THE INVENTION

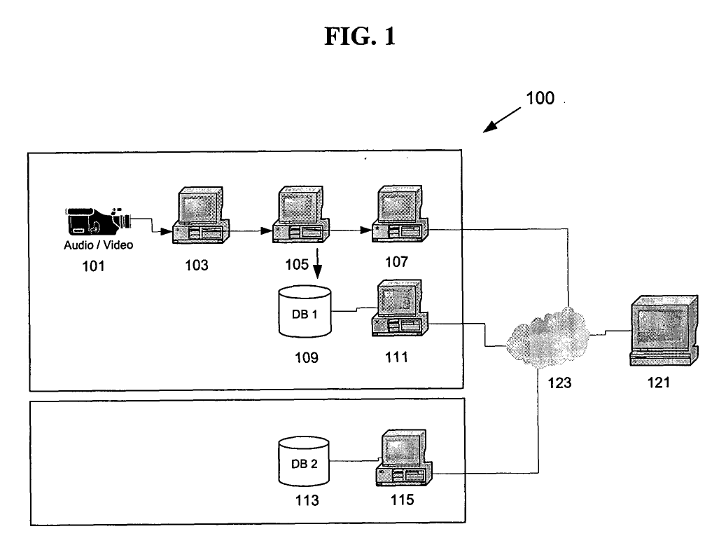

FIG. 1 shows a system (100) for providing dynamic encrypted streaming multimedia over a computer network according to the present invention.

The system (100) can include a media source (101), media encoder (103), media encryptor (105), media server (107), DB1 (109), media operator (111), DB2 (113), key bank (115) and client interface (121), each of which is connected with a computer network (123) that may include the Internet.

The media source (101) is configured to transmit streaming multimedia, which may or may not be encrypted, to the media encoder (103). The media source (101) may include any known media source, such as a digital video camera, stored audio/video data, etc. The encrypted streaming multimedia may be transmitted using known compression standards, such as MPEG-4. Typical multimedia content may include Pay-Per-View™ live media events, subscription Internet stations, intranet conferences and closed-circuit video applications.

The media encoder (103) may be configured to convert the audio or video content to a digital format (if not already in one) and to provide non-encrypted content stream to the media encryptor (105).

The media encryptor (105) may be configured to receive the non-encrypted content stream, dynamically encrypt the content stream, and transmit the encrypted streaming content to the media server (107).

The media server (107) may be configured to receive and manage requests received from users over network (123), and respond to the requests. The reply response generated by the system is described in more detail below.

The media operator (111) may be configured to host the multimedia content stream, such as via a web site or web page. The client interface (121) requests the multimedia content from the media operator (111).

The Media encoder (103), media encryptor (105), media server (107) media operator (111), key bank (115) and client interface (121) may be implemented using commercially available computer equipment, such as those including a conventional microprocessor such as a Pentium III™ 450 MHz microprocessor running a known operating system, such as Windows 2000 Server™. Such computer equipment should include adequate memory and disk storage, as well as appropriate network interface devices, such as a network interface controller and an A/V Capture Card/WM Codec 7 for Video. Client interface (121) may also be configured similarly.

Media encoder (103), media encryptor (105), media server (107), media operator (111) and client interface (121) may be configured as separate stand-alone computers, or they may all be configured to be housed on the same computer system. Also, media encoder (103), media encryptor (105), media server (107), media operator (111) and key bank (115) may be configured to run on any open operating system platform. Additionally, media encoder (103), media encryptor (105), media server (107), media operator (111), key bank (115) and client interface (121) may be configured to include a conventional web browser, such as Internet Explorer 5.5™.

Database DB1 (109) and DB2 (113) may be used to store and maintain important data related to the operation of the present invention, such as encryption keys, user profiles, data and broadcast requirements, etc., and therefore may include an appropriate database management system, such as SQL 7.0.

The system (100) may be implemented via a set of software modules. An exemplary ActiveX program is described in U.S. Provisional Patent Application Nos. 60/423,993, and 60/425,249 which have already been incorporated herein by reference.

Typically, a content provider defines and configures conditional access criteria for each content stream. The conditional access criteria allow the content provider to prevent the unauthorized reception (or interception) of information. These conditional access criteria may include, for example, whether the content stream may be purchased in advance. Key bank (115) uses the conditional access criteria to generate an activation code. The key bank (115) is operated as an interface between the content provider and the media operator (111).

The present invention is able to support at least a two level key hierarchy, including a Personal Key and a Channel Key. In a preferred embodiment, the Personal Key and the Channel Key are symmetric encryption keys, which require knowledge about which computers will be in communication so that one encryption key can be stored at the content stream source and the other encryption key can be stored at the client interface.

The Personal Key is a symmetric encryption key pair intended to protect the entitlement of the client interface (121). The Personal Key is generated within a Virtual Smart Card (VSC), a software functional equivalent of a hardware-based physical smart card that facilitates the transfer of data. The Personal Key is unique for each client interface (121) and is used to encrypt messages regarding the client interface (121).

The Channel Key is a symmetric encryption key pair that protects the content stream and access criteria information (i.e., access control information).

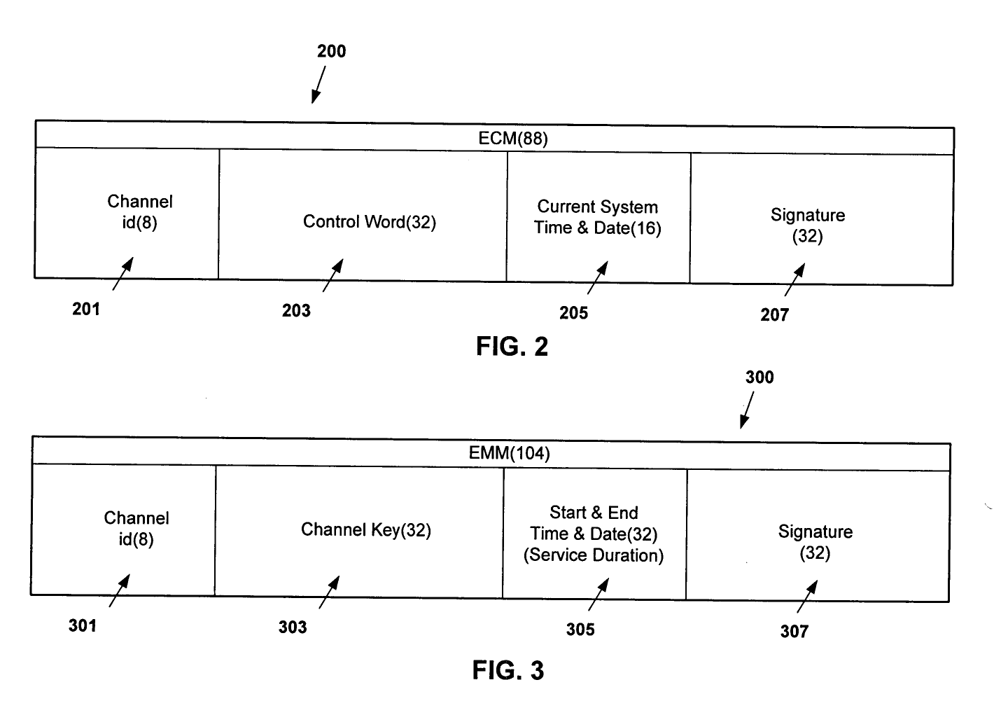

The content stream is encrypted using a control word pair. The control word may be embedded in an encrypted message to the client interface. Another encrypted message may be sent to the client interface with entitlement information, which allows an authorized user to access the control word, in order to decrypt the content stream and render the multimedia broadcast. In a preferred embodiment, an Entitlement Management Message (EMM) is used to provide access rights for each client interface (121) and an Entitlement Control Message (ECM) is used to define access criteria for each client interface (121). Example formats for these data packets for the ECM and the EMM are shown in FIGS. 2 and 3.

A preferred encryption standard is Advanced Encryption Standard (AES) symmetric key encryption algorithm of 128-bits key strength. However, the present invention is not limited to this encryption standard and can utilize any other standard, such as any encryption algorithm having more that 128-bit key size and an input/output block. The use of keys is well known in the art, as discussed in Cryptography Decrypted by H. X. Mel and Doris Baker, which is hereby incorporated by reference.

The EMM is dedicated to a specific client interface (121). The EMM provides the client interface (121) with particular rights. Therefore, for example, the client interface (121) must have the corresponding entitlement, such as the program code carried within the EMM in order to download an encrypted content stream. The EMM is encrypted by the Personal Key to transfer to a client interface (121).

The ECM is generated within the media encryptor (105). The functionality of the media encryptor (105) may be implemented by various software modules. One having ordinary skill in the art will readily understand that software programs may be written in a number of conventional languages, such as C++, ActiveX, etc.

The media encryptor (105) encrypts the content stream and generates an ECM when the content stream is scrambled. The ECM defines the content stream's access criteria. Therefore, the ECM is required so that the client interface has the right to decrypt the content stream. To encrypt the stream, media encryptor (105) uses a control word and performs real-time encryption. The ECM is encrypted by the Channel Key generated by media encryptor (105) and contains the conditional access criteria.

Because the ECM defines the content stream's access criteria, the ECM is dedicated to the content stream.

As shown in FIG. 2, ECM (200) may include an 8-byte channel id field (201), a 32-byte control word field (203), a 16-byte current system time field (205) and a 32-byte digital signature field (207). The digital signature resists tampering and ensures its integrity. The media encryptor (105) adds further access conditions to the encrypted content stream before the content stream is passed to the media server (107). The encrypted content stream, along with the conditional access requirement, is then transmitted via multicast or unicast over network (123).

FIG. 3 illustrates the format of an exemplary EMM. The EMM (300) is a 104 digit hexadecimal code (packet) that includes an 8-byte channel id field (301), a 32-byte encrypted Channel Key (303), a 32-byte service duration information field and a 32-byte digital signature field (307).

In the present invention, key bank (115) provides authorization and management control functions. The objective of key bank (115) is to keep count of the activated VSCs. Key bank (115) generates and releases the VSC with the EMM for an authorized client interface (121). To identify when a client interface (121) authorization request comes from an authorized source, key bank (115) signs the request and validates the signature before releasing the VSC. Key bank (115) personalizes a unique VSC for use by client interface (121) using a Personal Key. The Personal Key is configured according to the client interface (121) specific hardware information. Therefore, if the specific hardware information is changed, the VSC will become invalid because the VSC is generated as a unique software identifier for a specific client interface (121).

Each time the client interface (121) requests access to content streams over network (123), an EMM is created by media operator (111). The VSC can be, for example, an ActiveX object that contains the descrambler engine. The VSC is personalized by receiving an activation code from key bank (115). The VSC resides at the client interface and can accept an EMM from the media operator (111) in order to update the client interface (121) entitlement. When the client interface (121) entitlement is determined to be proper, the VSC decrypts the corresponding encrypted content stream by performing dynamic decryption according to the rights that have been embedded in the content stream by the media encryptor (105).

The VSC is configured to retrieve client interface information. The VSC is also configured to check the validity of the activation code and to store the activation code at the client interface. After activation, the VSC generates the Personal Key to decrypt the EMM. The VSC is further configured to set the corresponding entitlement to render a scrambled content stream. When the VSC succeeds in retrieving the encrypted content stream, and has proper entitlement to render the scrambled content, the VSC begins to decrypt the encrypted stream and render the decrypted stream at the client interface. To decrypt the content stream, client interface (121) must have received an authorized VSC with the appropriate service entitlement information EMM. Otherwise, the VSC cannot decrypt encrypted stream because it does not have a Channel key.

Key bank (115) is also configured to include a Voucher Verifier. The Voucher Verifier is configured to verify an issued voucher (400) and generate an activation code corresponding to the client system information. The voucher (400) verifies the location of the activation code request. The Voucher Verifier verifies the validity of a voucher signature and counts the number of VSCs downloaded from media operator (111). The Voucher Issuer may be ActiveX objects or the like, and may reside at the media operator (111). The key bank (115) logs the number of personalization requests with voucher (400) according to, for example a committed personalization license pack. Key bank (115) verifies the voucher signature, logs the voucher serial number and expiration serial number to ensure no duplicate request is possible using the same serial number.

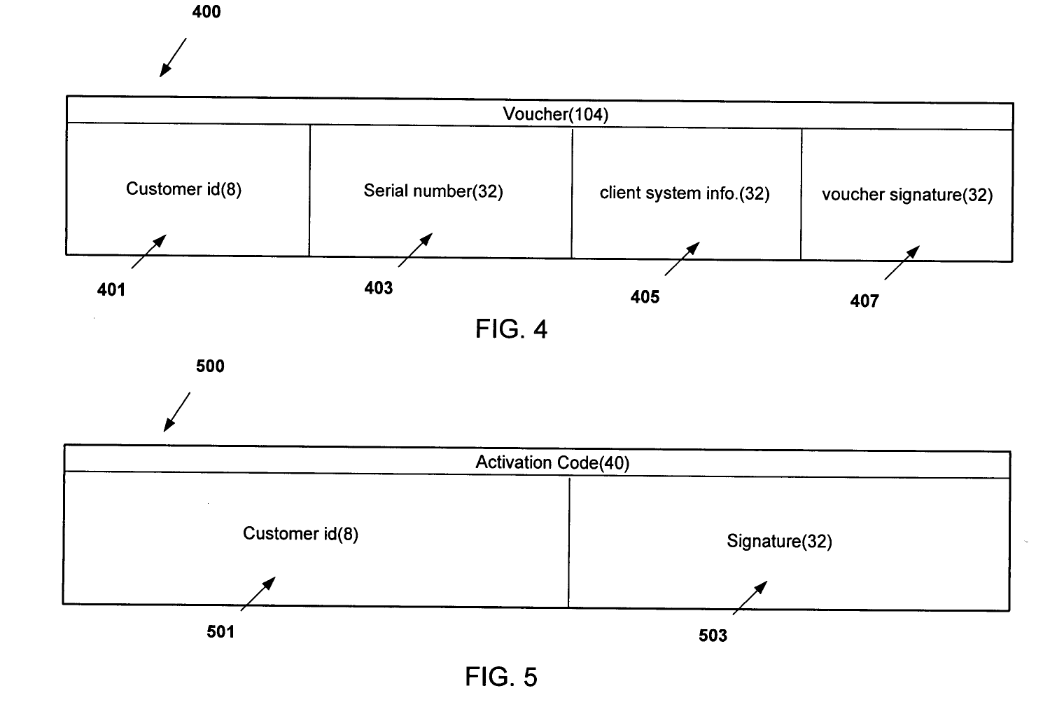

As shown in FIG. 4, voucher (400) can be a 104-digit hexadecimal and includes an 8-byte customer id field (401), a 32-byte serial number field (403), a 32-byte client system information field (405), and a 32-byte voucher signature (407).

The media operator (111) issues voucher (400) to make the VSC of a client personalized by using Voucher Issuer. If the transmitted voucher is valid, key bank (115) generates and transmits the corresponding activation code. During the processing, key bank (115) stores voucher (400) and the activation code (500).

As shown in FIG. 5, the activation code (500) is a 40-digit hexadecimal code. The activation code (500) includes an 8-byte customer id (501) and a 32-byte signature (503).

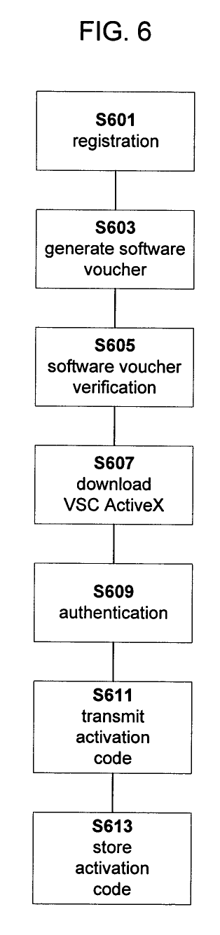

FIG. 6 shows a flow chart of a process for registering a user to receive an activation code over a computer network according to an embodiment of the present invention. Assume in this example that a user has access to the Internet, such as via client interface (121). The user may access a web site to register and submit a request a multimedia product, such as a live performance. As shown in FIG. 6, the client interface (121) accesses the media operator (111) and begins the registration process at step (S601). During the registration process, for example, the media operator (111) may require a credit card payment be made before the particular multimedia product can be requested. Additionally, the client interface (121) hardware information is retrieved in order to personalize the VSC. Next, media operator (111) then generates a software voucher (S603). The software voucher is verified (S605) by the key bank (115) to ensure that the request is from a valid source. Therefore, the software voucher is signed digitally so that key bank (115) knows the user's request is originated from a valid media operator (111). For example, because key bank (115) logs every activation code request, if a request comes from a source that is not identifiable, service may be denied. Additionally, if the client interface has exceeded the number of authorized VSC downloads for a particular time period, service may be denied. Next, upon successful verification (S605) and after the content stream is requested, the VSC ActiveX module is downloaded (S607) from the media operator (111) to the client interface (121). Key bank (115) then receives and validates the request (S609), and generates and transmits the activation code (S611). During this process, key bank (115) records the voucher and the activation code. Next, media Operator (111) sends the activation code received from key bank (115) to client interface (121) and stores the activation code corresponding to the previous voucher (S613).

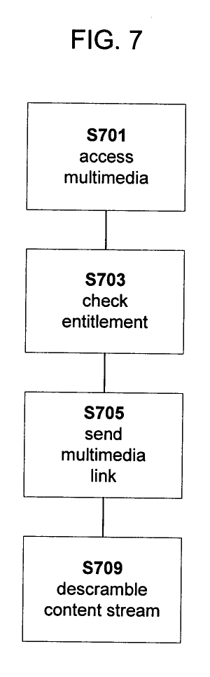

FIG. 7 shows a flow chart illustrating an example of a process to receive the multimedia product. Upon successful authentication at step S605, client interface (121) attempts to access the selected encrypted content stream (S701). Media operator (111) checks the entitlement of the selected stream (S703). The VSC cannot descramble the selected content stream without proper entitlement. For example, in order to decrypt the selected content stream, the client interface (121) must have a proper EMM containing the appropriate entitlement information. If it is determined that the client interface (121) does have the entitlement corresponding to the selected content stream, media operator (111 ) sends the link of the selected stream to the client interface (121) at step (S705). Next, the user at the client interface (121) may access the selected content stream by for example, “clicking” on the appropriate icon. At this point, the VSC descrambles the selected content stream (S709).

Thus, the present invention has been fully described with reference to the drawing figures. Although the invention has been described based upon these preferred embodiments, it would be apparent to those skilled in the art that certain modifications, variations, and alternative constructions would be apparent, while remaining within the spirit and scope of the invention.

We claim:

1. A method of receiving real-time multimedia via a network, comprising the steps of:
transmitting a request for the multimedia from a client interface, wherein the request obtains a reply response containing a control message having a first encryption key, a unique software identifier containing an entitlement message, which has a second encryption key, the control message defining content stream information and access criteria, and the entitlement message defining the client interface entitlement rights; and
receiving the reply, wherein the unique software identifier decrypts the multimedia in real-time, in accordance with the content stream information and access criteria, in order to render the multimedia at the client interface.

2. The method according to claim 1, wherein the unique software identifier is a virtual smart card.

3. The method according to claim 1, wherein the first encryption key and the second encryption key are symmetric encryption pairs.

4. The method according to claim 1, wherein the first encryption key protects the multimedia and permits the multimedia to be descrambled.

5. The method according to claim 1, wherein the second encryption key protects the entitlement rights and permits the rendering of the multimedia at the client interface.

6. The method according to claim 1, wherein the multimedia includes audio or video.

7. A method of providing real-time multimedia via the Internet, comprising the steps of:
receiving a request for multimedia;
validating the request;
if said request is authorized in the validating step, generating a reply response containing a control message having a first encryption key, a unique software identifier containing an entitlement message which has a second encryption key, the control message defining content stream information and access criteria, and the entitlement message defining the user interface entitlement rights; and
transmitting the reply response, the reply response being configured so that the unique software identifier decrypts the multimedia in real-time, in accordance with the content stream information and access criteria, in order to render the multimedia at the client interface.

8. The method according to claim 7, wherein the unique software identifier is a virtual smart card.

9. The method according to claim 7, wherein the first key and the second key are symmetric encryption pairs.

10. The method according to claim 7, wherein the first key protects the multimedia and permits the multimedia to be descrambled.

11. The method according to claim 7, wherein the second key protects the entitlement rights and permits the rendering of the multimedia at the client interface.

12. The method according to claim 7, wherein the multimedia includes audio or video.

13. A system for providing real-time multimedia:
a media source configured to generate an audio/video content stream;
a code generator configured to generate a plurality of distinct codes, a unique software identifier, and a plurality of messages;
a media encoder configured to convert the audio/video content stream to a particular format and to provide non-encrypted multimedia to a media encryptor;
a media encryptor configured to dynamically encrypt the non-encrypted multimedia with at least one distinct code and to transmit the encrypted multimedia to a media server;
a media server configured to store the encrypted multimedia and to provide the encrypted multimedia stream link to a web server;
a web server configured to register an end-user and to provide an encrypted multimedia stream link to the end-user; and
an end-user configured to receive the encrypted multimedia stream link and, wherein the unique software identifier is configured to decrypt the encrypted multimedia in real-time in order to render the multimedia at the end-user.

14. The system according to claim 13, wherein the unique software identifier is a virtual smart card.

15. The system according to claim 13, wherein the messages include a control message and an entitlement message.

16. The system according to claim 15, wherein the control message defines content stream information and access criteria, and the entitlement message defines the end-user entitlement rights.

17. The system according to claim 13, wherein the plurality of distinct codes include a first key and a second key.

18. The system according to claim 17, wherein the first and second keys are symmetric encryption pairs.

19. The system according to claim 17, wherein the first key protects the multimedia and permits the multimedia to be descrambled at the end-user.

20. The system according to claim 17, wherein the second key protects entitlement rights and permits the rendering of the multimedia at the end-user.

21. The system according to claim 17, wherein the first key is embedded in the control message.

22. The system according to claim 17, wherein the second key is embedded in the entitlement message.

23. The system according to claim 14, wherein the virtual smart card is a software functional equivalent of a physical smart card.

24. A method of providing broadcast content security, comprising the steps of:
registering with a web content provider;
requesting broadcast content from the web content provider;
requesting a software voucher from a media operator;
at a key bank, receiving and validating the request, then generating the activation code and a unique software identifier; and
sending the activation code and the unique software identifier to the end-user and storing the activation code corresponding to the previous voucher.

25. The method of providing broadcast content security according to claim 24, wherein the unique software identifier is in the form of a virtual smart card with an entitlement management message.

26. The method according to claim 24, wherein the software voucher is digitally signed so that the rights management control center can verify whether the request originated from a valid web server.

27. The method according to claim 24, wherein the broadcast content includes audio and video signals.

28. A method of accessing encrypted broadcast content stream, comprising the steps of:
selecting an encrypted broadcast content stream;
checking the entitlement of the encrypted broadcast content stream;
determining whether an end-user has entitlement corresponding to the encrypted broadcast content stream by means of a unique software identifier and an activation code;
sending a link for the encrypted broadcast content stream to the end-user; and decrypting the encrypted broadcast content stream.

29. The method according to claim 28, wherein the unique software identifier is in the form of a virtual smart card with an entitlement management message.

30. The method according to claim 28, wherein the broadcast content stream includes audio or video.

31. A system for dynamically receiving and displaying encrypted multi-media content, said system comprising:
a client interface coupled with a network, said client interface configured to generate a request for said content, wherein the request obtains a reply response containing a control message having a first encryption key, a unique software identifier containing an entitlement message, which has a encryption second key, the control message defining content stream information and access criteria, and the entitlement message defining the user interface entitlement rights, and
wherein the client interface is configured to download the reply response and decrypt the multimedia in real-time, in accordance with the content stream information and access criteria, in order to render the multimedia at the client interface.

32. The system according to claim 31, wherein the unique software identifier is a virtual smart card.

33. The system according to claim 31, wherein the first encryption key and the second encryption key are symmetric encryption pairs.

34. The system according to claim 31, wherein the first encryption key protects the multimedia and permits the multimedia to be descrambled.

35. The system according to claim 31, wherein the second encryption key protects the entitlement rights and permits the rendering of the multimedia at the client interface.

36. The system according to claim 31, wherein the multimedia includes audio or video.

37. The system according to claim 31, wherein the virtual smart card is a software functional equivalent of a physical smart card.

38. A system for dynamically providing and displaying encrypted multi-media content comprising:
a network server configured to receive and validate a request for multimedia;
an encryption component in communication with the network server and configured to generate a reply in response to the request, said response containing a control message having a first encryption key, a unique software identifier containing an entitlement message which has a second encryption key, the control message defining content stream information and access criteria, and the entitlement message defining the user interface entitlement rights; and
wherein the unique software identifier is configured to decrypt the multimedia in real-time, in accordance with the content stream information and acess criteria, in order to render the multimedia at a client interface.

39. The system according to claim 38, wherein the unique software identifier is a virtual smart card.

40. The system according to claim 38, wherein the first encryption key and the second encryption key are symmetric encryption pairs.

41. The system according to claim 38, wherein the first encryption key protects the multimedia and permits the multimedia to be descrambled.

42. The system according to claim 38, wherein the second encryption key protects the entitlement rights and permits the rendering of the multimedia at the client interface.

43. The system according to claim 38, wherein the multimedia includes audio and video.

44. A method for dynamically providing access control for broadcast content, comprising the steps of:
generating non-encrypted broadcast content;
configuring a plurality of distinct codes;
creating a unique software identifier;
generating a plurality of messages;
converting the broadcast content a particular format;
dynamically encrypting the broadcast content with at least one distinct code; and
transmitting the broadcast content to an end-user,
wherein the unique software identifier is configured to decrypt the broadcast content in real-time in order to render the broadcast content at the end-user.

45. The method according to claim 44, wherein the non-encrypted broadcast content is generated by a media source.

46. The method according to claim 44, wherein the plurality of distinct codes, the unique software identifier and the plurality of messages are generated by a code generator.

47. The method according to claim 44, wherein non-encrypted broadcast content is converted to a particular format by a media encoder.

48. The method according to claim 44, wherein the broadcast content is dynamically encrypted with at least one code by a media encryptor.

49. The method according to claim 44, wherein the unique software identifier is a virtual smart card.

50. The method according to claim 44, wherein the messages include a control message and an entitlement message.

51. The method according to claim 50, wherein the control message defines broadcast content stream information and access criteria, and the entitlement message defines the end-user entitlement rights.

52. The method according to claim 44, wherein the plurality of distinct codes include a first encryption key and a second encryption key.

53. The method according to claim 52, wherein the first and second encryption keys are symmetric encryption pairs.

54. The method according to claim 52, wherein the first encryption key protects the broadcast content and permits the broadcast content to be descrambled at the end-user.

55. The method according to claim 52, wherein the second encryption key protects entitlement rights and permits the rendering of the multimedia at the end-user.

56. The method according to claim 52, wherein the first encryption key is embedded in the control message.

57. The method according to claim 52, wherein the second encryption key is embedded in the entitlement message.

58. The method according to claim 44, wherein the broadcast content includes audio or video.

59. A system for providing real-time multimedia:
a means for generating an audio/video content stream;
a means for generating a plurality of distinct codes, a unique software identifier, and a plurality of messages;
a means for converting the audio/video content stream to a particular format and for providing non-encrypted multimedia to a media encryptor;
a means for dynamically encrypting the non-encrypted multimedia with at least one distinct code and to transmit the encrypted multimedia to a media server;
a means for storing the encrypted multimedia and to provide an encrypted multimedia stream link to a web server;
a means for registering an end-user and to provide the encrypted multimedia stream link to the end-user; and
a means for receiving the encrypted multimedia, wherein the unique software identifier is configured to decrypt the encrypted multimedia in real-time in order to render the multimedia at the end-user.

60. The system according to claim 59, wherein the unique software identifier is a virtual smart card.

61. The system according to claim 59, wherein the messages include a control message and an entitlement message.

62. The system according to claim 61, wherein the control message defines the content stream information, and the entitlement message defines the end-user entitlement rights.

63. The system according to claim 59, wherein the plurality of distinct codes include a first key and a second key.

64. The system according to claim 63, wherein the first and second keys are symmetric encryption pairs.

65. The system according to claim 63, wherein the first key protects the multimedia and permits the multimedia to be descrambled at the end-user.

66. The system according to claim 63, wherein the second key protects entitlement rights and permits the rendering of the multimedia at the end-user.

67. The system according to claim 63, wherein the first key is embedded in the control message.

68. The system according to claim 63, wherein the second key is embedded in the entitlement message.

69. The system according to claim 60, wherein virtual smart card is a software functional equivalent of a physical smart card.

70. A system for dynamically receiving and displaying encrypted multi-media content, said system comprising:
a means for interfacing coupled with a network, said interface means configured to generate a request for said content, wherein the request obtains a reply response containing a control message having a first encryption key, a unique software identifier containing an entitlement message, which has a encryption second key, the control message defining content stream information and access criteria, and the entitlement message defining the user interface entitlement rights,
wherein the interface means is configured to download the reply response and decrypt the multimedia in real-time, in accordance with the content stream information and access criteria, in order to render the multimedia at the interface means.

71. The system according to claim 70, wherein the unique software identifier is a virtual smart card.

72. The system according to claim 70, wherein the first encryption key and the second encryption key are symmetric encryption pairs.

73. The system according to claim 70, wherein the first encryption key protects the multimedia and permits the multimedia to be descrambled.

74. The system according to claim 70, wherein the second encryption key protects the entitlement rights and permits the rendering of the multimedia at the client interface.

75. The system according to claim 70, wherein the multimedia includes audio or video.

76. The system according to claim 70, wherein the virtual smart card is a software functional equivalent of a physical smart card.

77. A system for dynamically providing and displaying encrypted multi-media content comprising:
a means for receiving and validate a request for multimedia;
a means for encryption in communication with the receiving means and configured to generate a reply in response to the request, said response containing a control message having a first encryption key, a unique software identifier containing an entitlement message which has a second encryption key, the control message defining content stream information and access criteria, and the entitlement message defining the user interface entitlement rights;
wherein the unique software identifier is configured to decrypt the multimedia in real-time, in accordance with the content stream information and access criteria, in order to render the multimedia at a client interface.

78. The system according to claim 77, wherein the unique software identifier is a virtual smart card.

79. The system according to claim 77, wherein the first encryption key and the second encryption key are symmetric encryption pairs.

80. The system according to claim 77, wherein the first encryption key protects the multimedia and permits the multimedia to be descrambled.

81. The system according to claim 77, wherein the second encryption key protects the entitlement rights and permits the rendering of the multimedia at the client interface.

82. The system according to claim 77, wherein the multimedia includes audio and video.
